(19) United States
(12) Patent Application Publication
(10) Pub. No.: US 2023/0227359 A1
(43) Pub. Date: Jul. 20, 2023

(54) METHODS FOR MAKING POLY(OXYALKYLENE) ACRYLIC POLYMERS AT HIGH SOLIDS AND LOW VISCOSITY

(71) Applicant: Dow Global Technologies LLC, Midland, MI (US)

(72) Inventors: Michael T. Petr, Collegeville, PA (US); Thomas H. Kalantar, Midland, MI (US); Michael J. Radler, Midland, MI (US)

(21) Appl. No.: 18/002,520

(22) PCT Filed: Sep. 29, 2021
(86) PCT No.: PCT/US2021/052489

§ 371 Date: Dec. 20, 2022

Related U.S. Application Data
(60) Provisional application No. 63/087,393, filed on Oct. 5, 2020.

(51) Int. Cl. C04B 24/26

(52) U.S. Cl. CPC C04B 24/2647; C04B 2103/44

(57) ABSTRACT

The present invention provides methods of making an aqueous composition comprising polymerizing in the presence of one or more initiators at a pH of from 1 to 5 an aqueous monomer mixture of an aqueous medium and one or more acrylic or vinyl macromonomers containing an oxyalkylene chain group in the presence of one or more carboxylic acid group containing fluids chosen from a copolymerizable ethylenically unsaturated carboxylic acid, a polymeric polycarboxylic acid and mixtures thereof, to form a brush polymer-containing oxyalkylene side chain groups, wherein, the polymerizing takes place at a solids content ranging from 8 to 60 wt.%, and, combining one or more aromatic cofactors with the aqueous composition. In addition, the present invention provides aqueous compositions of brush polymers containing oxyalkylene side chain groups having more than one phase domain and a substantially reduced viscosity to enable processing with far less energy input or water waste.

The present invention relates to methods of making an aqueous composition comprising polymerizing an aqueous monomer mixture of one or more macromonomers containing an oxyalkylene chain group in the presence of one or more carboxylic acid group containing fluids chosen from a copolymerizable ethylenically unsaturated carboxylic acid, a polymeric polycarboxylic acid or mixtures thereof to form a brush polymer containing oxyalkylene side chain groups, wherein the polymerizing takes place at a pH of from 1 to 5, and to aqueous compositions comprising the brush polymer containing oxyalkylene side chain groups, and one or more aromatic cofactors, such as additive concentrates for use in cement. More particularly, it relates to methods comprising polymerizing an aqueous monomer mixture of one or more acrylic or vinyl macromonomers containing an oxyalkylene chain group in the presence of one or more carboxylic acid group containing fluids chosen from a copolymerizable ethylenically unsaturated carboxylic acid, a polymeric polycarboxylic acid, or mixtures thereof, wherein the polymerizing takes place at a pH of from 1 to 5, or, preferably, at a pH from 1 to 4.8; and, more particularly, it relates to aqueous compositions comprising one or more brush polymers-containing oxyalkylene side chain groups, one or more aromatic cofactors, and one or more carboxylic acid group containing fluids chosen from an ethylenically unsaturated carboxylic acid in copolymerized form as part of the brush polymer containing oxyalkylene side chain groups, a polymeric polycarboxylic acid, or mixtures thereof. The compositions of the present invention find use as thickeners and water retention compositions, such as, preferably, aqueous additive concentrates or powder compositions for use in cement containing compositions.

Cellulosics, including cellulose ethers, are well known as viscosity modifying agent (VMAs) additives for their thickening and water retention properties after the introduction of water to them. They may be used in concrete mixtures, for example, for cementing well casings used in oil and gas production, and in mortars from dry mixes, such as cement based tile adhesives (CBTA). Their water retention enables wet application of mortar to an absorbing substrate, such as, for example, stone, stone structures, concrete, concrete brick or clay brick walls, and enables proper setting before the mortar would dry out. Further, the thickening and water retention provided by a cellulose ether is dosage dependent, and this enables shear thinning and so, enables the highly controllable viscosity of compositions containing cellulose ethers in use. However, cellulose ethers are known to delay the cement setting reaction, resulting in lower strength properties in cement products. It would be desirable to enable provision of synthetic polymers as a way to enhance water retention in cement products without delaying cement cure.

Methoxypoly(ethylene glycol) methacrylate (MPEGMA) polymers in conjunction with β-naphthalene sulfonate (BNS) have been proposed as an alternative to cellulose ether containing water retention aids for use in cement compositions. However, a significant viscosity buildup occurs during the synthesis of the MPEGMA polymers, leading to such a high viscosity in water, for example, of over 1 × 10⁴ cP at just 10 wt.% solids, that it cannot be produced commercially. Drastically reducing synthesis solids to 5 wt.%, would undesirably lead to a low reactor output and the high energy demand needed to remove any additional amount of water from the composition.

U.S. Pat. Publication No. 2017/0240476 A1 to Baumann et al. discloses compositions of aqueous solutions or powders comprising one or more nonionic or substantially nonionic vinyl or acrylic brush polymers having pendant or side chain polyether groups, one or more aromatic cofactors containing one or more phenolic groups or, in combination, one or more aromatic groups with at least one sulfur acid group, and, further, one or more polycarboxylate ether copolymer water reducers. The compositions find use in cements. However, an unworkably high viscosity results in making the brush polymers and their compositions, even at unacceptably low solids contents.

The present inventors have sought to solve the problem of providing an aqueous polymer composition and methods for making such an aqueous composition that, when used as a viscosity modifying agent in cement admixtures, gives the thickening and water retention performance of cellulose ethers, at an acceptable solids content and without uncontrolled viscosity buildup in making the composition.

### SUMMARY OF THE INVENTION

In accordance with the present invention, aqueous compositions for use as thickeners and water retention compositions comprise an aqueous medium, preferably, an aqueous medium that is substantially free of organic solvent, one or more brush polymers-containing oxyalkylene side chain groups comprising, in polymerized or copolymerized form, one or more acrylic or vinyl macromonomers containing an oxyalkylene chain group, the polymerization residue of an initiator,
one or more aromatic cofactors, and,
one or more carboxylic acid group containing fluids chosen from:
   an ethylenically unsaturated carboxylic acid, preferably, acrylic or methacrylic acid, in copolymerized form as part of the brush polymer containing oxyalkylene side chain groups, a polymeric polycarboxylic acid, preferably, polyacrylic acid or polymethacrylic acid, or, more preferably, polyacrylic acid, or mixtures thereof,
wherein the composition has a pH of from 1 to 5, or, preferably, from 1 to 4.8 and, further wherein, the composition contains substantially no salt or no added salt excluding any one or more initiators or the polymerization byproducts thereof. Still further, in the aqueous compositions in accordance with the present invention, the aqueous medium is at least 90 wt.%, or, preferably, at least 98 wt.%, or, more preferably, at least 99 wt.% water. The aqueous compositions of the present invention may comprise the polymerization residue of one or more initiators, such as thermal or redox initiators, or, preferably, one or more thermal initiators, such as in the amount of up to 1 wt.%, based on the total solids of the brush polymer containing oxyalkylene side chain groups.

In accordance with the present invention, the aqueous compositions comprise a molar ratio of:
total moles of carboxylic acid, which total moles of carboxylic acid is defined as the total moles of ethylenically unsaturated carboxylic acid monomers used to make the one or more brush polymers containing oxyalkylene side chain groups plus the total moles of ethylenically unsaturated carboxylic acid monomers used to make the one or more polymeric polycarboxylic acids, and, if any polymeric polycarboxylic acids are not addition polymers, the total moles carboxylic acid groups in the total amount of the one or more polymeric polycarboxylic acids,
to total moles of oxyalkylene, which total moles of oxyalkylene is determined as the total moles of the one or more acrylic or vinyl macromonomers containing an oxyalkylene chain group used to make the one or more brush polymers containing oxyalkylene side chain groups multiplied by the average number of oxyalkylene chain groups in the total amount of acrylic or vinyl macromonomers containing an oxyalkylene chain group, as reported by the macromonomer manufacturer,
ranging from 0.1:1 to 10:1, or, preferably, from 0.2:1 to 5:1.

The aqueous compositions of the present invention may comprise a storage stable aqueous mixture or additive concentrate having a solids content ranging 8 wt.% or more, or, preferably, 10 wt.% or more, or, preferably, up to 60 wt.%, or, more preferably, 45 wt.% or less, or, more preferably, 12 wt.% or more, or, even more preferably, 30 wt.% or more, or, from 8 to 60 wt.%, or, preferably, from 10 to 60 wt.%, or, more preferably, from 12 to 45 wt.%. Further, the aqueous compositions may comprise a storage stable dry powder composition, such as for use as an additive. The dry powder composition in accordance with the present invention may further comprise hydraulic cement powder.

Preferably, the brush polymer containing oxyalkylene side chain groups in accordance with the present invention comprises a C₁ to C₄ alkoxy poly(C₂ to C₄ alkylene glycol) (meth)acrylate polymer or copolymer with one or more ethylenically unsaturated carboxylic acid in copolymerized form, or, more preferably, an alkoxy poly(ethylene glycol) (meth)acrylate polymer or copolymer with one or more ethylenically unsaturated carboxylic acid in copolymerized form, or, even more preferably, a methoxy poly(ethylene glycol) (meth)acrylate (MPEGMA) polymer or copolymer thereof with acrylic or methacrylic acid.

In accordance with another aspect of the present invention, methods of making an aqueous composition comprise polymerizing an aqueous monomer mixture of an aqueous medium, preferably, an aqueous medium that is substantially free of organic solvent, and one or more acrylic or vinyl macromonomers containing an oxyalkylene chain group in the presence of one or more carboxylic acid group containing fluids chosen from a copolymerizable ethylenically unsaturated carboxylic acid, preferably, acrylic or methacrylic acid, a polymeric polycarboxylic acid, preferably, polyacrylic acid or polymethacrylic acid, or, more preferably, polyacrylic acid, or mixtures thereof, to form a brush polymer containing oxyalkylene side chain groups. The polymerizing may take place in the presence of one or more initiators, such as a thermal or redox initiator, preferably, one or more thermal initiators, at a pH of from 1 to 5, or, preferably, from 1 to 4.8. The polymerizing of the present invention takes place at a solids content ranging from 8 wt.% or more, or, preferably, 10 wt.% or more, or, preferably, up to 60 wt.%, or, more preferably, 45 wt.% or less, or, more preferably, 12 wt.% or more, or, even more preferably, 30 wt.% or more, or, preferably, from 10 to 60 wt.%, or, more preferably, from 12 to 45 wt.%. The polymerizing of the present invention takes place in the presence of up to 1 wt.% or, from 0.01 to 0.6 wt.% of the one of more initiators, based on the total weight of monomers used to make the one or more brush polymers containing oxyalkylene side chain groups. Still further, in the polymerizing of the present invention, the aqueous medium of the aqueous monomer mixture is at least 90 wt.%, or, preferably, at least 98 wt.%, or, more preferably, at least 99 wt.% water. The methods in accordance with the present invention may further comprise drying the aqueous brush copolymer compositions to form a dry powder, or may further comprise combining one or more aromatic cofactors with the aqueous compositions.

Further, in accordance with the polymerizing of the aqueous monomer mixture of the present invention, a molar ratio of:
total moles of carboxylic acid, which total moles of carboxylic acid is determined as the total moles of ethylenically unsaturated carboxylic acid monomers used in the polymerizing of the one or more acrylic or vinyl macromonomers containing an oxyalkylene chain group plus the total moles carboxylic acid groups used to make the one or more polymeric polycarboxylic acids and, if any polymeric polycarboxylic acids are not addition polymers, the total moles of carboxylic acid groups in the one or more polymeric polycarboxylic acids,
to total moles of oxyalkylene, determined as the total moles of oxyalkylene used to make the one or more brush polymers of acrylic or vinyl macromonomers containing an oxyalkylene chain group or the total moles of acrylic or vinyl macromonomers multiplied by the average number of oxyalkylene chain groups in the total amount of acrylic or vinyl macromonomers containing an oxyalkylene chain group, as reported by the macromonomer manufacturer,
ranges from 0.1:1 to 10:1, or, preferably, from 0.2:1 to 5:1.

In accordance with the polymerizing the aqueous monomer mixture of the present invention, the total amount of the acrylic or vinyl macromonomer containing an oxyalkylene side chain group, based on the total weight of the brush polymer containing oxyalkylene side chain groups ranges from 20 to 100 wt.%, or, preferably, from 30 to 98 wt.%, or, preferably, 97 wt.% or less, or, more preferably, 50 wt.% or more, or, even more preferably, 65 wt.% or more, based on the total weight of monomers used to make the brush polymer containing oxyalkylene side chain groups.

In accordance with the polymerizing the aqueous monomer mixture of the present invention, the total amount of the one or more carboxylic acid group containing fluids, as solids, based on the total weight of the one or more brush polymers containing oxyalkylene side chain groups plus the one or more polymeric polycarboxylic acids ranges from 2 to 80 wt.%, or preferably, from 2 to 70 wt.% or, preferably, 50 wt.% or less, or, more preferably, 35 wt.% or less, or, even more preferably, 3 wt.% or more. Preferably, in the polymerizing the aqueous monomer mixture substantially no salt or no added salt, excluding any one or more initiators or the polymerization byproducts thereof.

Preferably, in the polymerizing of the present invention, the aqueous monomer mixture comprises as the one or more acrylic or vinyl macromonomers a C₁ to C₄ alkoxy poly(C₂ to C₄ alkylene glycol) (meth)acrylate polymer or a mixture thereof with one or more ethylenically unsaturated carboxylic acid, or, more preferably, comprises an alkoxy poly(ethylene glycol) (meth)acrylate polymer or a mixture thereof with one or more ethylenically unsaturated carboxylic acids, or, even more preferably, comprises a methoxy poly(ethylene glycol) (meth)acrylate (MPEGMA) polymer or a mixture thereof with acrylic or methacrylic acid.

In accordance with the methods of the present invention, the methods may further comprise, after the polymerizing, drying or obtaining as a separate powder each of the one or more brush polymers and the one or more aromatic cofactors, and then mixing them to form a dry powder blend. Alternatively, the methods in accordance with the present invention may comprise wet methods of, after the polymerizing, adding in any order to the aqueous composition of one or more brush polymers containing oxyalkylene side chain groups, the one or more aromatic cofactors, or a mixture thereof to form a stable aqueous composition. The wet methods may further comprise adding one or more polycarboxylate ether copolymer water reducers to the aqueous composition of the brush polymer containing oxyalkylene side chain groups or a mixture thereof with one or more aromatic cofactors.

The singular forms “a,” “an,” and “the” include plural referents unless the context clearly dictates otherwise. Unless defined otherwise, the terms used herein have the same meaning as is commonly understood by one skilled in the art.

Unless otherwise indicated, any term containing parentheses refers, alternatively, to the whole term as if no parentheses were present and the same term without that contained in the parentheses, and combinations of each alternative. Thus, the term “(meth)acrylate” encompasses, in the alternative, methacrylate, or acrylate, or mixtures thereof.

The endpoints of all ranges directed to the same component or property are inclusive of the endpoint and independently combinable. Thus, for example, a disclosed range of a solids content ranging from 8 wt.% or more, or, preferably, 10 wt.% or more, or, more preferably, 12 wt.%, or more, or, preferably, up to 60 wt.%, or, even more preferably, 30 wt.% or more, or, preferably, up to 60 wt.%, or, more preferably, 45 wt.% or less, or, even more preferably, 30 wt.% or more, or, preferably, from 10 to 60 wt.%, or, more preferably, from 12 to 45 wt.%, or, even more preferably, from 30 to 45 wt.% means any or all of solids contents ranging from 8 wt.% to 60 wt.%, or, from 8 to 10 wt.%, or, from 8 to 12 wt.%, or, from 8 wt.% to 30 wt.%, or, from 8 to 45 wt.%, or, preferably, from 10 to 60 wt.%, or, more preferably, from 12 to 60 wt.%, or, more preferably, from 12 to 45 wt.%, or, even more preferably, from 30 to 45 wt.%, or, preferably, from 10 to 12 wt.%, or, preferably, from 10 to 30 wt.%, or, preferably, from 10 to 45 wt.%, or, more preferably, from 12 to 45 wt.%, or, more preferably, from 12 to 30 wt.%, or, even more preferably, from 30 to 45 wt.%, or, more preferably, from 30 to 60 wt.%, or, preferably, from 45 to 60 wt.%.

Unless otherwise indicated, conditions of temperature and pressure are room temperature (23° C.) and standard pressure (101.3 kPa), also referred to as “ambient conditions”. And, unless otherwise indicated, all conditions include a relative humidity (RH) of 50 %.

All ranges recited are inclusive and combinable. For example, a disclosure of from 0.25 to 0.5 wt.%, or, preferably, from 0.35 to 0.45 wt.%, will include all of from 0.25 to 0.5 wt.%, or, preferably, from 0.35 to 0.45 wt.%, or, from 0.25 to 0.35 wt.%, or, from 0.25 to 0.45 wt.%, or, from 0.35 to 0.5 wt.%, or, from 0.45 to 0.5 wt.%.

As used herein, the term “acrylic or vinyl” refers to addition polymerizable monomers or addition polymers of α, β-ethylenically unsaturated monomers, such as, for example, alkyl and hydroxyalkyl (meth)acrylates, vinyl ethers, ethylenically unsaturated carboxylic acids, alkyl (meth)acrylamides, or oxyalkylene chain group containing monomers, such as, for example, methoxy poly(ethylene glycol) (meth)acrylate (mPEG(M)A) or poly(ethylene glycol) (meth)acrylate (PEG(M)A) and allyl poly(ethylene glycol) (APEG).

As used herein the term “aqueous” means that the continuous phase or medium is water and from 0 to 10 wt.%, based on the weight of the medium, of water-miscible compound(s). Preferably, “aqueous” means water.

As used herein, unless otherwise indicated, the term “average number of oxyalkylene chain groups” refers to the number of oxyalkylene groups in any given acrylic or vinyl macromonomers having an oxyalkylene chain group, as indicated in the manufacturer’s literature for a given macromonomer. As this is an average number, the actual number of oxyalkylene chain groups represents a distribution within each material batch; and the average number of oxyalkylene chain groups in a mixture of two or more such macromonomers will depend on the relative amount of each of the selected macromonomers having an oxyalkylene chain to the total amount of the macromonomers in the monomer mixture. For example, in a 50:50 (mol/mol) mixture of an alkoxypoly(ethylene glycol) (meth)acrylate having 10 ethylene glycol groups in each oxyalkylenechain and an alkoxypoly(propylene glycol) (meth)acrylate having 6 propylene glycol groups in each oxyalkylenechain, the average number of oxyalkylene groups is 8 per side chain.

As used herein, the term “based on the total weight of monomers” refers to the amount of a polymer or portion thereof compared to the total weight of addition monomers used to make the polymer, such as, for example, acrylic monomers.

As used herein the term “dry mix” or “dry powder” means a storage stable powder containing cement, cellulose ether, any other polymeric additive, and any fillers and dry additives. No water is present in a dry mix; hence it is storage stable.

As used herein, the term “fluid” or “fluids” refers to a composition of matter that flows, regardless of its state of matter or phase. Fluids may include suspensions, dispersions, solutions, fluidized solids or amorphous materials, aerosols, or gases.

As used herein, the term “side chain” group refers to a side chain of a polymer or a group that is covalently linked to the backbone of a polymer and which is not an endgroup.

As used herein, unless otherwise indicated, the phrase “polymer” includes both homopolymers and copolymers from two or more than two differing monomers, as well as segmented and block copolymers.

As used herein, the term “storage stable” means that, for a given powder additive composition, the powder will not block and, for a given aqueous additive composition, the liquid composition will not become cloudy, separate or precipitate after 5 days, or, preferably, 10 days when allowed to stand on a shelf under room temperature conditions and standard pressure.

As used herein, the term “substantially free of organic solvent” means that the composition comprises less than 0.5 wt.%, based on the total weight of the composition of any one or more organic solvents, or, preferably, contains no added organic solvent, or, more preferably, contains 1000 ppm or less of any one or more organic solvents.

As used herein, the phrase “total moles carboxylic acid groups” means the number of moles of ethylenically unsaturated carboxylic acid monomers used to make a given polymer or, if not an addition polymer, the total moles of carboxylic acid groups in the one or more polymeric polycarboxylic acids, as determined by aqueous titration of the given polymer against KOH to neutralize the composition to a pH of 7.0.

As used herein, the term “weight average molecular weight” for a brush polymer containing oxyalkylene side chain groups means the weight average value taken from the weight distribution determined by gel permeation chromatography (GPC) using poly(acrylic acid) standards as needed to resolve the molecular weight of the given polymer.

As used herein, unless otherwise indicated, the term “wt.%” means weight percent based on the indicated denominator.

As used herein, the phrase “total solids”, “solids” or “as solids” refers to total amounts of any or all of the non-volatile ingredients or materials present in a given composition, including synthetic polymers, monomers, natural polymers, acids, defoamers, hydraulic cement, fillers, inorganic materials, and other non-volatile materials and additives, such as initiators. Water, ammonia and volatile solvents are not considered solids.

In accordance with the present invention, the methods of polymerization in aqueous media comprise polymerizing monomers that form a solution in water. However, the polymerization product of the methods of the present invention behave in a manner like a two-phase polymerization, such as a stable suspension or emulsion polymerization; and, further, aqueous compositions containing brush copolymers, such as those made by the methods, behave like an emulsion or stable suspension. At a pH at or below the pKa of an ethylenically unsaturated carboxylic acid in the aqueous monomer mixture or brush polymer compositions of the present invention, an associative complex forms among the protonated carboxylic acid groups and the oxyalkylene groups of the oxyalkylene side chain of the brush polymer. Thus, the present invention enables the polymerizing of a highly water soluble acrylic or vinyl macromonomer containing an oxyalkylene chain group at an acceptably high solids content while minimizing energy and water usage in process. An example of a suitable macromonomer comprises a methoxypoly(ethylene glycol) methacrylate (MPEGMA).

The present invention enables a substantial viscosity reduction in the aqueous monomer mixtures, in their polymerization, and in aqueous brush polymer compositions containing oxyalkylene side chain groups. For comparison, aqueous compositions of the same monomer mixture or a brush polymer thereof were used comprising the macromonomer alone or mixed with one or more monomers having a water solubility of less than 1 wt.% in deionized (DI) water at 23° C. and 101.3 KPa pressure, such as an alkyl (meth)acrylate, styrene or vinyl ester monomer, such as methyl methacrylate (MMA). The polymerization in accordance with the methods of the present invention enabled an in-process viscosity reduction at 10 wt.% MPEGMA total polymer solids of from above 10⁴ cP to below 10² cP. Further, in another example of the methods of the present invention, an aqueous monomer mixture comprising 15 wt% methacrylic acid (MAA), based on the total weight of monomers enabled an in-process viscosity reduction before, during and after polymerization at 10 wt.% MPEGMA total monomer/polymer solids of from above 10⁴ cP to below 10² cP. In the comparative MPEGMA aqueous monomer mixtures/brush polymers in both of the above examples, 15 wt.% methyl methacrylate (MMA) was used.

Particularly, the present inventors have discovered polymerizable aqueous monomer mixtures of an acrylic or vinyl macromonomer containing an oxyalkylene chain group and aqueous compositions of a brush polymer of the same macromonomer in (co)polymerized form that have more than one phase domain, similar to an emulsion or suspension. The aqueous compositions of the brush polymer made from the aqueous monomer mixtures of the present invention behave in the same manner as the aqueous monomer mixture from which they are made. The aqueous brush polymer compositions in accordance with the present invention comprise one or more carboxylic acid group containing fluids chosen from polymeric polycarboxylic acids, such as polyacrylic acid or poly(methacrylic acid) (pMAA), or mixtures thereof, an ethylenically unsaturated carboxylic acid in copolymerized form, such as methacrylic acid (MAA) in copolymerized form, or their combination. In addition, the present invention provides methods of making the aqueous brush polymer compositions comprising polymerizing one or more acrylic or vinyl macromonomers containing an oxyalkylene chain group in the presence of one or more carboxylic acid group containing fluids chosen from the one or more polymeric polycarboxylic acids or a copolymerizable ethylenically unsaturated carboxylic acid, or their combination.

The one or more acrylic or vinyl brush polymer containing oxyalkylene side chain groups in accordance with the present invention may be chosen from a homopolymer of an acrylic or vinyl macromonomer having an oxyalkylene chain group or a copolymer of the one or more macromonomers and one or more ethylenically unsaturated carboxylic acid monomers. The aqueous compositions of the present invention may not have a polymeric polycarboxylic acid where they comprise a brush copolymer containing one or more ethylenically unsaturated carboxylic acids in copolymerized form.

The acrylic or vinyl brush polymers of the present invention can comprise any such polymers having oxyalkylene side chain groups, preferably, poly(ethylene glycol) groups or alkoxy poly(ethylene glycol) groups. The oxyalkylene side chain groups can be, for example, poly(alkylene glycol) side chains terminated with hydroxyl, methyl, ethyl or any other non-ionic group not bearing a charge at the pH of the composition. The side chains can be alkylene glycols (EO, PO, BO, etc.) or mixtures thereof. Suitable oxyalkylene side chain groups may be chosen from poly(alkylene glycol)s, such as poly(ethylene glycol)s, poly(propylene glycol)s, poly(butylene glycol)s or copolyethers of two or more thereof; alkoxy poly(alkylene glycol)s, such as methoxy poly(alkylene glycol)s, ethoxy poly(alkylene glycol)s and their combination. Preferably, the oxyalkylene side chain groups in the vinyl or acrylic brush polymers of the present invention have from 5 to 25, or, more preferably, from 7 to 15 ether groups or alkylene glycol groups. More preferably, the ether groups are ethoxy (—CH₂CH₂O—) or (EO) groups.

The backbone of the vinyl or acrylic brush polymers of the present invention may include repeating units of one or more ethylenically unsaturated carboxylic acid, such as acrylic or methacrylic acid; however, the repeating units are not limited to these. The vinyl or acrylic brush polymers of the present invention can also be synthesized using any other unsaturated monomers, such as vinyl-, allyl-, or isoprenyl- groups in amounts of up to 10 wt.% of monomer solids.

In the acrylic or vinyl macromonomer containing an oxyalkylene chain group and the acrylic or vinyl brush polymer containing oxyalkylene side chain groups of the present invention, the average number of oxyalkylene side chain groups in the one or more macromonomers or in the brush polymer containing oxyalkylene side chain groups ranges from 1.5 to 100 ether groups, for example, 2 or more, or, 3 or more, or, from 1.5 to 50 ether groups, or, preferably, from 2 to 40, or, more preferably, from 3 to 40, or, more preferably, from 5 to 25 ether groups, or, even more preferably, from 7 to 15 ether groups. Preferably, the macromonomers used to make the brush polymer containing oxyalkylene side chain groups of the present invention have in the oxyalkylene groups with from 5 to 25 total alkylene glycol or ether units, such as 7 or more alkylene glycol or ether units, or, up to 15 alkylene glycol or ether units.

Suitable acrylic or vinyl brush polymers containing oxyalkylene side chain groups may be the polymerization product of from 20 to 100 wt.%, or, preferably, from 30 to 100 wt.%, or, preferably, from 40 to 70 wt.%, or, preferably, 50 wt.% or more, or, preferably, up to 98 wt.%, or, more preferably, from 65 to 100 wt.%, such as from 65 to 98 wt.%, based on the total weight of the monomers used to make the polymer, of the one or more acrylic or vinyl macromonomers having an oxyalkylene chain group. Preferably, the remainder of the monomers used to make the polymer is one or more ethylenically unsaturated carboxylic acids.

Suitable acrylic or vinyl macromonomers for use in the polymerizing or making the brush polymers of the present invention may be any macromonomer having a poly(alkylene glycol) chain with the desired number of ether or alkylene glycol units. Preferably, the acrylic or vinyl macromonomers used to make the vinyl or acrylic brush polymers of the present invention are methacrylate monomers having an oxyalkylene chain group, such as poly(ethylene glycol) (meth)acrylates; alkoxy poly(alkylene glycol) (meth)acrylates, such as C₁ to C₄ alkoxypoly(C₂ to C₄ alkylene glycol) (meth)acrylates; hydrophobic C₁₂ to C₂₅ alkoxy poly(alkylene glycol) (meth)acrylates; or their mixtures. More preferably, the one or more acrylic or vinyl macromonomers having an oxyalkylene chain group comprise a poly(ethylene glycol) (meth)acrylate, methoxy poly(ethylene glycol) (meth)acrylate or mixtures thereof.

Suitable acrylic or vinyl macromonomers may comprise poly(ethylene glycol) (meth)acrylate or its corresponding (meth)acrylamide having from 2 to 50 ethylene glycol units, poly(propylene glycol) (meth)acrylate or its corresponding (meth)acrylamide having from 2 to 50 propylene glycol units, a C₁₂ to C₂₅ alkoxy poly(ethylene glycol) (meth)acrylate or its corresponding (meth)acrylamides having from 2 to 50 ethylene glycol units and, a C₁₂ to C₂₅ alkoxy poly(propylene glycol) (meth)acrylate or its corresponding (meth)acrylamide having from 2 to 50 propylene glycol units, polybutylene glycol (meth)acrylate or its corresponding (meth)acrylamide having from 2 to 50 total alkylene glycol units, poly(ethylene glycol)-poly(propylene glycol) (meth)acrylate or its corresponding (meth)acrylamide having from 2 to 50 total alkylene glycol repeat units, poly(ethylene glycol)-poly(butylene glycol) (meth)acrylate or its corresponding (meth)acrylamide having from 2 to 50 total alkylene glycol units, poly(propylene glycol)-poly(butylene glycol) (meth)acrylate or its corresponding (meth)acrylamide having from 2 to 50 total alkylene glycol units, poly(ethylene glycol)-poly(propylene glycol)-poly(butylene glycol) (meth)acrylate or its corresponding (meth)acrylamide having from 2 to 50 total alkylene glycol units, methoxy poly(ethylene glycol) (meth)acrylate or its corresponding (meth)acrylamide having from 2 to 50, or, preferably, from 5 to 25 ethylene glycol units, methoxy poly(propylene glycol) (meth)acrylate or its corresponding (meth)acrylamide having from 2 to 50, or, preferably, from 5 to 25 propylene glycol units, methoxy poly(butylene glycol) (meth)acrylate or its corresponding (meth)acrylamide having from 2 to 50, or, preferably, from 5 to 25 total alkylene glycol units, methoxy poly(butylene glycol) mono(meth)acrylate or its corresponding (meth)acrylamide having from 2 to 50 total alkylene glycol units, methoxy poly(ethylene glycol)-poly(propylene glycol) (meth)acrylate or its corresponding (meth)acrylamide having from 2 to 50 total alkylene glycol units, methoxy poly(ethylene glycol)-poly(butylene glycol) (meth)acrylate or its corresponding (meth)acrylamide having from 2 to 50 total alkylene glycol units, methoxy poly(propylene glycol)-poly(butylene glycol) (meth)acrylate or its corresponding (meth)acrylamide having from 2 to 50 total alkylene glycol units, methoxy poly(ethylene glycol)-poly(propylene glycol)-poly(butylene glycol) (meth)acrylate or its corresponding (meth)acrylamide having from 2 to 50 total alkylene glycol units, ethoxy poly(ethylene glycol) (meth)acrylate or its corresponding (meth)acrylamide having from 2 to 50 or, preferably, from 5 to 25 ethylene glycol units, poly(ethylene glycol) (meth)allyl ether or monovinyl ether having from 2 to 50 ethylene glycol units, poly(propylene glycol) (meth)allyl ether or monovinyl ether having from 2 to 50 propylene glycol units, poly(ethylene glycol)-poly(propylene glycol) (meth)allyl ether or monovinyl ether having from 2 to 50 total alkylene glycol units, poly(ethylene glycol)-poly(butylene glycol) (meth)allyl ether or monovinyl ether having from 2 to 50 total alkylene glycol units, poly(propylene glycol)-poly(butylene glycol) (meth)allyl ether or monovinyl ether having from 2 to 50 total alkylene glycol units, methoxy poly(ethylene glycol) (meth)allyl ether or monovinyl ether having from 2 to 50 ethylene glycol units, methoxy poly(propylene glycol) (meth)allyl ether or monovinyl ether having from 2 to 50 propylene glycol units, and the corresponding monoesters, monoamides, diesters and diamides of itaconic or maleic acids, or mixtures of any of the foregoing.

More particularly, suitable acrylic or vinyl macromonomers having an oxyalkylene chain group may include one or more of any of poly(ethylene glycol)₄₋₄₀ (meth)acrylates, such as poly(ethylene glycol)₄₋₄₀ (meth)acrylates; alkoxy poly(alkylene glycol)₄₋₄₀ (meth)acrylates, such as C₁ to C₄ alkoxy poly(C₂ to C₄ alkylene glycol)₄-₄₀ (meth)acrylates, C₁ to C₄ alkoxy poly(C₂ to C₄ alkylene glycol)₄₋₄₀ (meth)acrylates alkoxy poly(ethylene glycol)₄₋₄₀ (meth)acrylates; or hydrophobic C₁₂ to C₂₅ alkoxy poly(alkylene glycol)₄₋₄₀ (meth)acrylates such as. The acrylic or vinyl macromonomers preferably comprise C₁ to C₄ alkoxy poly(C₂ to C₄ alkylene glycol)₄₋₄₀ (meth)acrylates and poly(ethylene glycol)_{1.5-100} (meth)acrylates, and, more preferably, comprise poly(ethylene glycol)₄₋₄₀ (meth)acrylates and C₁ to C₄ alkoxy poly(ethylene glycol)_{4 - 40} (meth)acrylates, or, even more preferably, comprise methoxy poly(C₂ to C₄ alkylene glycol)₄₋₄₀ (meth)acrylates and poly(ethylene glycol)₄₋₄₀ (meth)acrylates.

An example of a suitable acrylic or vinyl brush polymer of the present invention is a (co)polymer of an acrylate or acrylamide macromonomer having an oxyalkylene chain group, such as poly(ethylene glycol) with one or more ethylenically unsaturated carboxylic acid monomers.

Suitable ethylenically unsaturated carboxylic acids for use in making the aqueous brush polymers of the present invention containing oxyalkylene side chain groups and carboxylic acid groups may include any one or more monomer bearing carboxylic acids, such as, for example, methacrylic acid, acrylic acid, crotonic acid, fumaric acid, maleic acid, 2-methyl maleic acid, itaconic acid, citraconic acid, mesaconic acid, 2-methyl itaconic acid, cyclohexenedicarboxylic acid, α,β-methylene glutaric acid, monoalkyl maleates, and monoalkyl fumarates; ethylenically unsaturated anhydrides such as, for example, maleic anhydride, itaconic anhydride, citraconic anhydride, mesaconic anhydride, acrylic anhydride, and methacrylic anhydride.

Further, the aqueous brush polymer compositions in accordance with the present invention can comprise, in copolymerized form, one or more comonomers having a water solubility of less than 1 wt.% in deionized (DI) water at 23° C. and 101.3 kPa pressure. Suitable comonomers may include any of C₁ to C₁₂ alkyl (meth)acrylates, like lower alkyl (C₁ to C₈) alkyl (meth)acrylates, such as methyl methacrylate (MMA), ethyl acrylate (EA), and 2-ethylhexyl methacrylate (2-EHA); hydroxyalkyl (meth)acrylates, such as hydroxyethyl methacrylate; arylenes, such as styrene; vinyl ester monomers; and mixtures thereof. Such comonomers can comprise up to 10 wt.% solids, or, preferably, up to 5 wt.% solids, based on the total weight of monomers used to make the brush polymer. Where the aqueous compositions comprise one or more polymeric polycarboxylic acid as the one or more carboxylic acids, the amount of such comonomers may be higher, for example, up to 80 wt.%, or, for example, up to 40 wt.%, based on the total weight of the monomers used to make the brush polymer.

The aqueous brush polymer containing oxyalkylene side chain groups of the present invention may be crosslinked, but is, preferably, not crosslinked. Crosslinking may result from methods such as by including in the aqueous monomer mixture from 0.01 to 1 wt.%, or, preferably, up to 0.1 wt.% of one or more diethylenically unsaturated crosslinker monomers, such as (poly)glycol di(meth)acrylates, like (poly)ethylene glycol dimethacrylates or (poly)ethylene glycol diacrylates; allyl acrylate or allyl methacrylate; or their combination, based on the total weight of the monomers used to make the polymer.

Preferably, to insure that the aqueous compositions of one or more brush polymers containing oxyalkylene side chain groups of the present invention exhibit water retention and not water reduction, such polymers comprise the polymerization product of less than 0.1 wt.% or, preferably, less than 0.05 wt.% of any salt containing monomer, such as an ethylenically unsaturated carboxylic acid salt monomer, based on the total weight of monomers used to make the brush polymer.

In accordance with the aqueous compositions of the present invention, suitable brush polymers containing oxyalkylene side chain groups may have a weight average molecular weight (relative Mw) of from 100,000 to 50,000,000 g/mol, or, preferably, 250,000 or more, or, more preferably, 300,000 or more, or, preferably, 20,000,000 or less, or, more preferably, 10,000,000 or less.

The one or more polymeric polycarboxylic acids in accordance with the polymerization methods and the aqueous compositions in accordance with the present invention may comprise any polymer of one or more ethylenically unsaturated carboxylic acids or, if not an addition polymer, a carboxylic acid functional polymer, such as poly(aspartic acid). The polymer includes, in copolymerized form, one or more monomer bearing carboxylic acids, such as, for example, methacrylic acid, acrylic acid, crotonic acid, fumaric acid, maleic acid, 2-methyl maleic acid, itaconic acid, citraconic acid, mesaconic acid, 2-methyl itaconic acid, cyclohexenedicarboxylic acid, α,β-methylene glutaric acid, monoalkyl maleates, and monoalkyl fumarates; ethylenically unsaturated anhydrides such as, for example, maleic anhydride, itaconic anhydride, citraconic anhydride, mesaconic anhydride, acrylic anhydride, and methacrylic anhydride. Such monomers should be used in in amounts that provide acid copolymerized units in the amount of from 50 to 100 wt.%, or, preferably, 80 wt.% or more, based on the weight of all monomers used to make polymer. The remainder of the polymeric polycarboxylic acids, aside from copolymerized acid group-containing units, may comprise hydroxyl group containing copolymerized units, and, optionally, copolymerized units of additional ethylenically unsaturated monomers. Accordingly, the copolymer and the copolymeric polyacid may comprise, as copolymerized units, hydroxyl group containing ethylenically unsaturated monomers, and, optionally, as copolymerized units, additional ethylenically unsaturated monomers.

In the methods of making the aqueous compositions of brush polymer containing oxyalkylene side chain groups in accordance with the present invention, the polymerizing comprises conventional aqueous addition polymerization. The polymerization may proceed by conventional free radical addition polymerization in the presence of a thermal or a redox initiator, or, preferably, a thermal initiator such as, for example, aqueous emulsion polymerization in the presence of one or more persulfates or a peracid. The polymerization may be done as a shot of the aqueous monomer mixture, added together or separately, or may comprise gradual addition of the one or more monomers in the aqueous monomer mixture, added together or separately, in one or more stages. The polymerization may be conducted in an aqueous medium at a temperature of from 40 to 80° C., or, more preferably, 71° C. or less. Preferably, the methods of making the brush polymer containing oxyalkylene side chain groups in accordance with the present invention comprises conventional free radical addition aqueous polymerization, such as shot polymerization wherein the aqueous monomer mixture is added to a reaction vessel all at one time.

More preferably, the polymerizing to form the brush polymer containing oxyalkylene side chain groups of the present invention is conducted in an aqueous medium with a thermal initiator, at a temperature from 40 to 75° C., or, most preferably, 71° C. or less. Most preferably, the polymerizing to form the brush polymer containing oxyalkylene side chain groups of the present invention is conducted in aqueous medium with a thermal initiator, at a concentration of 0.05 wt.% to 1 wt.%, based on the total weight of monomers (monomer solids) used to make the polymer, or, even more preferably, 0.2 wt.% or less.

The aqueous compositions of the one or more brush polymer containing oxyalkylene side chain groups have a pH of 5 or below, for example, from 1 to 5, or, preferably, 4.8 or less, or, for example, from 1 to 4.8.

The aqueous compositions of the one or more brush polymer containing oxyalkylene side chain groups comprise less than 1 wt.%, based on the total solids weight of the composition, of salt, or, preferably, comprise no added salt except for salt as part of a polymerization initiator or the polymerization byproducts thereof. If a salt is used, it is preferably a monovalent metal salt, such as a sodium salt, or ammonium salt.

In accordance with the aqueous polymerizing methods of the present invention, the one or more polymeric polycarboxylic acid comprises a polymer or copolymer of one or more ethylenically unsaturated carboxylic acids, in copolymerized form. Suitable ethylenically unsaturated carboxylic acids may include as, for example, methacrylic acid, acrylic acid, crotonic acid, fumaric acid, maleic acid, 2-methyl maleic acid, itaconic acid, citraconic acid, mesaconic acid, 2-methyl itaconic acid, cyclohexenedicarboxylic acid, α,β-methylene glutaric acid, monoalkyl maleates, and monoalkyl fumarates; ethylenically unsaturated anhydrides such as, for example, maleic anhydride, itaconic anhydride, citraconic anhydride, mesaconic anhydride, acrylic anhydride, and methacrylic anhydride. Preferably, the ethylenically unsaturated carboxylic acid is acrylic or methacrylic acid. Such monomers should be used in the copolymer or the copolymeric polyacid in amounts that provide acid copolymerized units in the amount of from 65 to 100 wt.%, preferably, from 80 to 100 wt.%, based on the weight of the monomers used to make the polymeric polycarboxylic acid. The remainder of the one or more polymeric polycarboxylic acids (aside from copolymerized acid group-containing units) may comprise hydroxyl or amide group containing in copolymerized form, hydroxyl group containing ethylenically unsaturated monomers, such as hydroxyethyl methacrylate, and amide group containing monomers, such as (meth)acrylamide. The polymeric polycarboxylic acids can be made by conventional aqueous addition polymerization, such as in the presence of one or more initiators.

In accordance with the methods and the aqueous compositions of the present invention, the polymeric polycarboxylic acids contain less than 1 wt.% of carboxylic acid salts, based on the total weight of monomers used to make the polymeric polycarboxylic acid, or, preferably, contain no salt.

The one or more aromatic cofactors of the present invention can be any compound, polymer or oligomer having one or more and up to 1,000,000, or up to 100,000, or, preferably, two or more, or, more preferably, three or more aromatic groups or phenolic groups, such as, for example, phenolic or naphtholic groups, wherein when the aromatic cofactor has aromatic groups other than phenolic groups it further contains at least one sulfur acid group. Preferably, the aromatic cofactor of the present invention has one or more aromatic group and at least one sulfur acid group, or, more preferably, two or more such combinations. The cofactors can include beta naphthalene sulfonate (BNS) resin, styrene sulfonate (co)polymers, and lignin sulfonates, as well as phenolic resins, and tannins. Aromatic cofactors may include, for example, a poly(naphthalene sulfonate) formaldehyde condensate resin or polymer, such as a beta-naphthalene sulfonate formaldehyde condensate polymer or beta naphthalene sulfonate resin (BNS), a poly(styrene-co-styrene sulfonate) copolymer, catechol tannins, phenolic resins, such as phenol formaldehyde resins, polyphenolics, napthhols, such as 2-naphthol, and mixtures thereof. Preferably, the aromatic cofactor is branched and, more preferably, is BNS.

The aromatic cofactor of the present invention has one or more aromatic or phenolic groups on from 10 to 100%, or, preferably, from 30 to 100%, or, more preferably, from 50 to 100% or from 60 to 100% of the repeat units of the oligomer or polymer. For example, each of a phenol formaldehyde resin or a naphthalene sulfonate aldehyde resin is considered a homopolymer or oligomer having, respectively, phenolic groups or aromatic groups in 100% of its repeating units. Preferably, in oligomers or polymers having aromatic and sulfur acid groups in combination, more than 30 wt.% or, preferably, more than 50 wt.%, of the aromatic groups are accompanied by a sulfur acid group, such as, for example, poly(stryrene-co-styrene sulfonate) copolymers which are the copolymerization product of more than 30 mole % of styrene sulfonate, based on the total number of moles of vinyl monomers used to make the copolymer.

The aromatic cofactor may be linear, as in styrene sulfonate containing polymers, and is, preferably, branched, as in any condensate resin, such as naphthalene sulfonate aldehyde or phenol aldehyde condensates, tannins or lignin sulfonates. Where the cofactor is linear, it preferably has a molecular weight of 600,000 to 10,000,000.

Suitable examples of aromatic cofactors are commercially available, including MELCRETE™ 500 powder (BASF, Ludwigshafen, DE) and the liquid version thereof, MELCRETE™ 500 L liquid (BASF). Both are BNS polymers or oligomers. MELCRETE™ 500 polymer is a sulfonated naphthalene condensate with formaldehyde.

The compositions of the present invention can be used in wet (aqueous) or dry powder form. Wet aqueous compositions are used with wet cement and dry powders are used with dry cement. The aromatic cofactor of the present invention can be used in wet or dry form and can be combined, wet or dry, with the brush polymer containing oxyalkylene side chain groups to make an additive composition. Drying to form dry powder compositions may be done by spray drying the aqueous composition of any polymer or cofactor, or both, or heating, preferably, in a vacuum oven, or by an azeotropic method as described in the prior art prior to combining with cement powder.

In the compositions of the present invention, the brush polymer containing oxyalkylene side chain groups and the one or more aromatic cofactors may be combined such that in use the total weight of brush polymer to the total weight of the cement admixture, as solids, ranges from 0.05 to 2 wt.%, or, preferably, from 0.1 to 1 wt.%.

The aqueous compositions of the present invention may be used by admixing them with hydraulic binders or cement and water to make concrete or cement admixture, or by drying them and admixing with dry cement before combining with water at the time of use. The compositions of the present invention can be combined with hydraulic cements in any manner so long as the aromatic cofactor and, if used, any polycarboxylate ether copolymer water reducer is not added to wet cement prior to addition of the brush polymer containing oxyalkylene side chain groups to the wet cement. Preferably, the compositions of the present invention comprise a single aqueous composition that is added to wet concrete or cement.

When the compositions of the present invention further comprise a hydraulic or moisture curing inorganic cement, the total amount of the one or more brush polymers, as solids, ranges from 0.05 to 2 wt.%, or, preferably, from 0.1 to 1 wt.%, or, more preferably, from 0.2 to 0.5 wt.%, based on total cement solids. Further, the compositions may comprise the one or more aromatic cofactors, as solids, in a range of from 0.1 to 10 wt.%, or, preferably, from 0.2 to 5 wt.%, or, more preferably, from 0.2 to 2 wt.%, based on total cement solids.

The aqueous compositions or dried powders of the present invention may further comprise a cellulose ether, such as HPMC and/or HEMC (hydroxyethyl methyl cellulose), or a water reducer, such as a polycarboxylate ether. The total amount of any polycarboxylate ether copolymer water reducer in the compositions may range from 0.1 to 10 wt.%, or, preferably, from 0.2 to 5 wt.% of the total cement solids content of the cement admixture.

The compositions of the present invention can contain, in addition, conventional additives in wet or dry form, such as, for example, cement setting accelerators and retarders, air entrainment agents or defoamers, shrinking agents and wetting agents; surfactants, particularly nonionic surfactants; spreading agents; mineral oil dust suppressing agents; biocides; plasticizers; organosilanes; anti-foaming agents such as poly(dimethylpolysiloxanes) (PDMS) and emulsified PDMS, silicone oils and ethoxylated nonionics; and coupling agents such as, epoxy silanes, vinyl silanes and hydrophobic silanes.

### EXAMPLES

The following examples illustrate the present invention. Unless otherwise indicated, all parts and percentages are by weight and all temperatures are in °C and all preparations and test procedures are carried out at ambient conditions of room temperature (23° C.) and pressure (1 atm). In the examples and Tables 1, 2, and 3 that follow, the following abbreviations were used: RDP: Redispersible Polymer Powder; MPEGMA: Methoxypoly(ethylene glycol) methacrylate; MAA: Methacrylic acid; AA: Acrylic acid; MMA: Methyl methacrylate; EO: Ethylene oxide.

All chemicals aside from AA, MMA and MAA were purchased from Sigma-Aldrich and used with no further purification.

Synthesis Example 1: Polymeric Polycarboxylic Acid A 50 wt.% solids poly(acrylic acid) additive was synthesized in a 1 L round bottom flask. 103.5 g of water was added, stirred at 170 rpm, and heated to 73° C. under a flow of nitrogen gas. Then 1.25 g of a 0.15 wt% iron (ll) sulfate solution and 2.83 g of sodium meta-bisulfite dissolved in 5.94 g of water were added. Next, feeds of 40.76 g sodium meta-bisulfite dissolved in 63.31 g of water, 150 g of AA rinsed with 3.5 g of water, and 0.57 g of sodium persulfate dissolved in 8.5 g of water were started simultaneously and fed over 70, 90, and 95 minutes, respectively. The temperature gradually rose to 75° C., and after the end of the sodium persulfate solution feed, the temperature was held at 75° C. for 15 additional minutes. Following this hold, 0.21 g of sodium persulfate dissolved in 10.0 g of water was added over 10 minutes, and then the reactor was held at 75° C. for an additional 20 minutes. After cooling to 60° C., 4.8 g of 35 wt% hydrogen peroxide was added over 2 minutes, and then the reactor was held at 60° C. for an additional 10 minutes. Finally, the reactor was cooled to room temperature.

Synthesis Example 2: Brush Polymer Compositions Containing Oxyalkylene Side Chain Groups and A Separate Polymeric Polycarboxylic Acid The brush polymers of Comparative Example 1 and Inventive Examples 1, 2, and 3 were synthesized in a 300 mL flat bottom flask and stirred with an impeller at 120 rpm. 12.8 g of MPEGMA-500 (having an average of 9 EO units and a molar mass of 500 g), 2.2 g of MMA, and water and 50 wt% polyacrylic acid solution from synthesis Example 1, above, were added to the reactor. The solution was heated to 70° C. under nitrogen for 1 hr. Next, a solution of 0.030 g of ammonium persulfate in 1.875 g of water was added and rinsed in with an additional 1.875 g of water. The temperature was maintained at 70° C. for 2 hr, and then an additional solution of 0.030 g of ammonium persulfate in 1.875 g of water was added and rinsed in with an additional 1.875 g of water. The temperature was again maintained at 70° C. for 2 hr and then cooled to room temperature. The compositions of this synthesis example 2 and a polymeric polycarboxylic acid are presented in Table 1, below.

Synthesis Example 3: Brush Polymer Compositions Containing Oxyalkylene Side Chain Groups and A Carboxylic Acid in Copolymerized Form The brush polymer of Inventive Example 4 was synthesized in a 1 L round bottom flask. 451.1 g of water, 21.3 g of MPEGMA-500, and 3.7 g of MAA were added to the reactor, and each monomer was rinsed in with an additional 6.2 g of water. The solution was heated to 70° C. under nitrogen for 1 hr. Next, a solution of 0.050 g of ammonium persulfate in 3.124 g of water was added and rinsed in with an additional 3.124 g of water. The temperature was maintained at 70° C. for 2 hr, and then an additional solution of 0.050 g of ammonium persulfate in 3.124 g of water was added and rinsed in with an additional 3.124 g of water. The temperature was again maintained at 70° C. for 2 hr and then cooled to room temperature. The compositions made by this synthesis example 3 are presented in Table 3, below.

The brush polymer of Inventive Example 5 was synthesized in a 1 L round bottom flask. 401.6 g of water, 42.5 g of MPEGMA-500, and 7.5 g of MAA were added to the reactor, and each monomer was rinsed in with an additional 12.5 g of water each. The solution was heated to 70° C. under nitrogen for 1 hr. Next, a solution of 0.100 g of ammonium persulfate in 6.249 g of water was added and rinsed in with an additional 6.249 g of water. The temperature was maintained at 70° C. for 2 hr, and then an additional solution of 0.100 g of ammonium persulfate in 6.249 g of water was added and rinsed in with an additional 6.249 g of water. The temperature was again maintained at 70° C. for 2 hr and then cooled to room temperature. The compositions made by this synthesis example 3 are presented in Table 3, below.

TABLE 1

Compositions From Synthesis Example 1 Made With Poly(Acrylic Acid) Additive

| Example | AA:EO (mol/mol) | Water (g) | Poly(acrylic acid) solution (g) | Total Solids (wt.%) |
|---|---|---|---|---|
| Comparative 1* | 0 | 128.0 | 0 | 8.50 wt% |
| 1 | 0.5 | 119.6 | 16.7 | 13.10 wt% |
| 2 | 1 | 111.3 | 33.4 | 17.40 wt% |
| 3 | 1.5 | 103.0 | 50.0 | 21.85 wt% |

*- Denotes Comparative Example.

Test Methods: The following test methods were used:

Solids Content: The solids content was measured by weighing the indicated amount of a given composition and then evaporating the water in a 60° C. oven. Solids contents for the indicated example are set forth in Tables 2 and 3, below.

Solution Viscosity: Solution viscosities were measured with a Brookfield viscometer with the spindle indicated at frequencies of 10 and 30 rpm, as indicated. The solution viscosity results for the indicated example are set forth in Tables 2 and 3, below.

TABLE 2

Brookfield Viscosity Data For Examples Made With Poly(Acrylic Acid) Polymer

| Example | AA:EO (mol/mol) | Total Solids (wt.%) | Spindle | Frequency (rpm) | Viscosity (cP) | Frequency (rpm) | Viscosity (cP) |
|---|---|---|---|---|---|---|---|
| Comparative 1* | 0 | 8.50 | 65 | 10 | 19000 | 30 | 11000 |
| 1 | 0.5 | 13.10 | 63 | 10 | 1000 | 30 | 932 |
| 2 | 1 | 17.40 | 63 | 10 | 160 | 30 | 148 |
| 3 | 1.5 | 21.85 | 62 | 10 | 60 | 30 | 63 |

*- Denotes Comparative Example.

TABLE 3

Brookfield Viscosity Data For Examples With Methacrylic Acid As Comonomer.

| Example | Comonomer | Total Solids (wt.%) | Spindle | Frequency (rpm) | Viscosity (cP) | Frequency (rpm) | Viscosity (cP) |
|---|---|---|---|---|---|---|---|
| Comparative 1* | 15 wt.% MMA | 8.50 | 65 | 10 | 19000 | 30 | 11000 |
| 4 | 15 wt.% MAA | 4.55 | 61 | 10 | - | 30 | 5.8 |
| 5 | 15 wt.% MAA | 8.55 | 61 | 10 | 130.2 | 30 | 93.8 |

*- Denotes Comparative Example.

As is illustrated in the data listed in

Table 2, above, the Inventive Examples made in the presence of the polyacrylic acid contain 10 wt% MPEGMA copolymer solids content but yield a much lower viscosity than that of the Comparative Example. This reduction in viscosity is proportional to the amount of poly(acrylic acid) added. It is important to note that all the Examples and Comparatives have the same MPEGMA copolymer content. However, the overall solids content increased with the amount of the poly(acrylic acid) added; despite this, the measured viscosity decreased with the amount of the poly(acrylic acid) added. Finally, Table 3, above, lists the viscosities of Inventive Examples 4 and 5, which comprise an acrylic brush polymer-containing oxyalkylene side chain groups and, in copolymerized form, MAA as the comonomer. The compositions of Examples 4 and 5 exhibited dramatically reduced viscosities, even at the same solids content as in Comparative Example 1.

1. An aqueous composition for use as a thickener and water retention aid comprising: an aqueous medium;
one or more brush polymer containing oxyalkylene side chain groups comprising, in polymerized or copolymerized form, one or more acrylic or vinyl macromonomers containing an oxyalkylene chain group, and the polymerization residue of an initiator; one or more aromatic cofactors; and
one or more carboxylic acid group containing fluids chosen from:
an ethylenically unsaturated carboxylic acid, in copolymerized form as part of the brush polymer containing oxyalkylene side chain groups, a polymeric polycarboxylic acid, or mixtures thereof,
wherein the aqueous medium is at least 90 wt.% water; and,
further wherein, the composition has a pH of from 1 to 5 and has a solids content ranging from 8 to 60 wt.%.

2. The aqueous composition as claimed in claim 1, having a pH of from 1 to 4.8 and, further wherein, the composition contains substantially no salt or no added salt excluding any one or more initiators or the polymerization byproducts thereof.

3. The aqueous composition as claimed in claim 1, comprising a molar ratio of:
total moles carboxylic acid, which total moles of carboxylic acids are determined as the total moles of ethylenically unsaturated carboxylic acid monomers used to make the one or more brush polymer containing oxyalkylene side chain groups plus the total moles of ethylenically unsaturated carboxylic acid monomers used to make the one or more polymeric polycarboxylic acids, and, if any polymeric polycarboxylic acids are not addition polymers, the total moles of carboxylic acid groups in the one or more polymeric polycarboxylic acids,
to total moles of oxyalkylene, which total moles of oxyalkylene is determined as the total moles of the one or more acrylic or vinyl macromonomers containing an oxyalkylene chain group used to make the one or more brush polymers containing oxyalkylene side chain groups, multiplied by the average number of oxyalkylene chain groups in the total amount of acrylic or vinyl macromonomers containing an oxyalkylenechain group, as reported by the macromonomer manufacturer,
ranging from 0.1:1 to 10:1.

4. The aqueous composition as claimed in claim 3, wherein the molar ratio of total moles of carboxylic acid to total moles of oxyalkylene ranges from 0.2:1 to 5:1.

5. The aqueous composition as claimed in claim 1, comprising a storage stable aqueous mixture or additive concentrate having a solids content ranging from 10 to 40 wt.%.

6. A method of making an aqueous composition comprising:
polymerizing in the presence of one or more initiators at a pH of from 1 to 5 an aqueous monomer mixture of an aqueous medium and one or more acrylic or vinyl macromonomers containing an oxyalkylene chain group in the presence of one or more carboxylic acid group containing fluids chosen from a copolymerizable ethylenically unsaturated carboxylic acid, a polymeric polycarboxylic acid, or mixtures thereof, to form a brush polymers containing oxyalkylene side chain groups,
wherein the aqueous portion of the aqueous monomer mixture comprises at least 90 wt.% of water, and, further wherein, the polymerizing takes place at a solids content ranging from 8 to 60 wt.%.

7. The method as claimed in claim 6, wherein, in the polymerizing the aqueous monomer mixture has a pH of from 1 to 4.8; and,
further wherein, the aqueous monomer mixture contains substantially no salt or no added salt excluding any one or more initiators.

8. The method as claimed in claim 6, wherein in the polymerizing the aqueous monomer mixture, a molar ratio of:
total moles carboxylic acid, determined as the total moles of ethylenically unsaturated carboxylic acid monomers used in the polymerizing the one or more macromonomers containing an oxyalkylene chain group plus the total moles of ethylenically unsaturated carboxylic acid monomers used to make the one or more polymeric polycarboxylic acids, and, if any polymeric polycarboxylic acids are not addition polymers, the total moles carboxylic acid groups in the one or more polymeric polycarboxylic acids,
to total moles of oxyalkylene, determined as the total moles of acrylic or vinyl macromonomer polymer-containing oxyalkylene side chain groups used to make the one or more brush polymer-containing oxyalkylene side chain groups multiplied by the average number of oxyalkylene chain groups in the total amount of acrylic or vinyl macromonomers containing an oxyalkylene chain group, as reported by the macromonomer manufacturer,
ranges from 0.1:1 to 10:1.

9. The method as claimed in claim 6, wherein the total amount of the acrylic or vinyl macromonomer containing an oxyalkylene chain group ranges from 20 to 100 wt.%, based on the total weight of monomers used to make the brush polymer- containing oxyalkylene side chain groups.

10. The method as claimed in claim 6, wherein the polymerizing takes place at a solids content of from 10 to 45 wt.%.

11. The method as claimed in claim 6, wherein the aqueous monomer mixture comprises as the one or more acrylic or vinyl macromonomers a C₁ to C₄ alkoxy poly(C₂ to C₄ alkylene glycol) (meth)acrylate.
